(19) United States
(12) Patent Application Publication
(10) Pub. No.: US 2006/0092474 A1
(43) Pub. Date: May 4, 2006

(54) System and method for image processing

(75) Inventors: Thomas E. Ramsay, Minneapolis, MN (US); Kenneth W. Richards, Richfield, MN (US); Michael K. Wackerfuss, St. Paul, MN (US); Arnold E. Murray, Chisago City, MN (US); Philip N. Petersen, Plymouth, MN (US)

Correspondence Address: MERCHANT & GOULD PC, P.O. BOX 2903, MINNEAPOLIS, MN, 55402-0903, US

(73) Assignee: Visualgold.Com, Inc., Hopkins, MN (US)

(21) Appl. No.: 11/028,959

(22) Filed: Jan. 3, 2005

Related U.S. Application Data
(63) Continuation of application No. 09/707,144, filed on Nov. 6, 2000, now abandoned.
(60) Provisional application No. 60/184,088, filed on Feb. 22, 2000.

(51) Int. Cl. H04N 1/409

(52) U.S. Cl. 358/3.27

(57) ABSTRACT

Image processing system and method automatically process a series of input images without operator's intervention. Each of the input images is automatically analyzed, classified, enhanced and/or compressed. Individual image enhancement is applied to each of the input images independently. A plurality of enhanced and/or compressed images can be outputted without re-analyzing and re-classifying the input image. The processed images have a high compression to quality ratio, produce images having quality and visual characteristics as viewed by a human including image contrast, brightness, and sharpness as compared with the input image, while capable of reducing the amount of memory required for storing the output images. The image processing system and method can process the images in real time on-the-fly or in a batch mode, and can operate in a wire and/or wireless transmission environment or embedded in a hardware, firmware, or software which is embedded in another system or application. The system can be a stand-alone system or a server/client network system, etc.

### RELATED APPLICATIONS

This application is a continuation of U.S. patent application Ser. No. 09/707,144, filed on Nov. 6, 2000, which claims the benefit of Provisional Application, U.S. Ser. No. 60/184,088, filed on Feb. 22, 2000, entitled “SUPER JPEG BUILDER AND METHOD FOR IMAGE ENHANCEMENT,” by Kenneth Richards, Thomas Ramsay, and Michael Wackerfuss, the entireties of which are hereby incorporated by reference herein.

### TECHNICAL FIELD

The present invention relates to image processing, more particularly, to an image processing system and method for automatically processing images without operator's intervention.

### BACKGROUND OF THE INVENTION

Considerable research and development have been conducted over the past few years in image processing fields, for example, image compression to reduce an image file size, or image enhancement to improve an image quality, etc.

Typically, image data are large in size and often required to be compressed to a smaller size before they are stored and/or transmitted in media. Various methods have been developed to compress an image file. For example, in U.S. Pat. No. 5,426,512, a method of digital compression of images is disclosed. The patented method uses a DCT transform coefficients yielded from a Discrete Cosine Transform (DCT) of all the blocks as well as other display and perceptual parameters to generate a quantization matrix which in turn yields a reproduced image having a low perceptual error. The patented method adapts or customizes the individual quantization matrix to the image being compressed.

One of the problems associated with existing image compression methods is that these compression methods do not apply any pre-compression filtering to reduce image quality degradation as the compression is applied, e.g. sharpening of images, removing artifacts, etc. Under a high compression setting, an image generally loses its image characteristics/attributes. Further, compression of images introduces artifacts. These methods of compression do not take into account for preparing the image prior to compression to reduce the visible artifacts so as to maximize the compression applied and retain visual qualities. Images that have been 1) previously compressed with an algorithm, for example, JPEG (Joint Photographic Expert Group); 2) having a dot pattern from being scanned; 3) GIF images that have dots because of their dithering or color pallet being limited to some number of colors, have varying degrees of artifacts dependent upon the compression applied.

Some existing image processing systems apply enhancement to original and previously compressed images to enhance the image quality. When automated, the same enhancement parameters are applied to all images of the batch process such as contrast or brightness without taking into account for the individual qualities of each image to be enhanced. Thus, these existing image enhancement systems may not enhance a batch processed image, but degrade the quality and/or visual characteristics of the image as viewed by a human. In addition, artifacts problems still remain.

Another problem that resides in conventional image enhancement systems is that the image processing requires an operator's intervention. Typically, an operator randomly chooses image processing parameters, such as sharpness, contrast percentage, etc., enhances an image based on the chosen parameters, and judges whether the enhanced image is acceptable. If not, different image processing parameters are chosen to enhance an original image. This process is time consuming. This process is more or less depending on operator's experience. U.S. Pat. No. 5,694,484 has addressed these concerns and attempts to solve the problem. However, the system still requires an operator's intervention, even though it is minimized. For example, an operator needs to select image processing operations to process an input image. Further, as mentioned above, like many other existing image enhancement systems, this patented system does not enhance an image to a point that the image has quality and/or visual characteristics as viewed by a human and does not pre-process the image prior to compression so as to reduce image quality degradation or artifacts introduced by the compression method and thus allow a greater degree of compression to be applied while retaining visual qualities.

Furthermore, existing enhancement and compression methods do not take into account for image quality such as sharpness as the size of the image is reduced. This is particularly true with thumbnail images where the amount of information that defines the image and its characteristics are very small. Thus, small images, such as thumbnails, have poor visual quality.

A further problem of conventional image enhancement systems is that an input image must be loaded into a memory repeatedly for each multiple output desired. This slows down the processing time and wastes many resources.

It is with respect to these and other considerations that the present invention has been made.

### SUMMARY OF THE INVENTION

In accordance with this invention, the above and other problems were solved by providing an image processing system and method capable of automatically analyzing, classifying, enhancing, pre-compression processing, and compressing each of a series of input images on-the-fly without operator's intervention in a wire and/or wireless transmission environment or embedded in a hardware, software, or firmware device, and outputting one or more enhanced images without re-analyzing, re-classifying, and re-enhancing the input image.

The present invention provides an image processing system and method which automatically generates one or more highest quality images in given file sizes. Also, the present invention provides a system capable of processing a series of input images in a batch mode or in real time on-the-fly. Accordingly, the system in accordance with the principles of the present invention can function as a round-the-clock “professional image processing specialist” with speed and skill levels unmatched by any human counterpart.

Further, the present invention provides a system and method which greatly improve high-contrast or over- or under-exposed pictures, images generated from document scanners or digital cameras, etc.

Furthermore, the present invention provides an image processing system and method for generating enhanced and/or compressed images having a high compression to quality ratio, such as a JPEG image, and enhanced uncompressed images, such as a BMP (Bitmap) or TIFF (.tif) image. For example, the system produces an image having quality and visual characteristics as viewed by a human including image brightness, contrast, and sharpness as compared with an original uncompressed image, while reducing the amount of memory required for storing the file.

In one embodiment of the present invention, each input image is analyzed for its unique luminosity and/or color characteristics/attributes, classified, and enhanced to improve its visual qualities. The method includes automatically analyzing a luminosity histogram associated with a particular image and deriving at least three statistical functions for the luminosity histogram, the statistical functions include a Weighted Mean (WM) function, a Half Value Position (HVP) function, and a Weighted Standard Deviation (WSD) function; and automatically classifying the image by its statistical functions, which are compared against set parameters for each class of images that are derived from experimental data stored in tables or a database structure. The experimental data can be a collection of human experienced/perceptive data about images from which tables or a knowledge based database is built. The method further includes automatically applying a predetermined set of changes to the image based upon its class.

The system and method in accordance with the present invention further include all interfaces and logics capable of operating in real time and static environments as part of an application or as a stand-alone utility, for example, on a stand-alone computer, a server-based network, or the Internet, etc. The interfaces provide control of an operator defined quality and compression settings which can be defined on an individual image basis or specified as a rule set for all images processed until such time as another rule set is applied. These settings define the methodology for analysis of the file type to achieve the compression to quality ratio specified. In addition, the system and method are capable of performing pre-image compression enhancement for any known or future compression algorithm, such as JPEG, Wavelet, Fractal, etc. This is also made possible for outputting an enhanced uncompressed image file type, such as BMP or TIFF, etc.

The present invention also addresses the issues of artifacts introduced into images due to the source or previous processing of the image. The artifacts are reduced by applying filters, such as a “Blur” filter that tends to “smear/smudge” the blocking generated as a result of compression or similar to a blocking of dot patterns created by scanned images or GIF. The “Blur” filter reduces the appearance of the blocking throughout the whole picture. The blocking artifacts and the picture details are both blurred. However, the edges that define the original picture content can be restored by applying multiple iterations of the unsharp mask filter in varying amounts (e.g. 15%/15%/15%) whereupon the edges are slowly redefined. Furthermore, the pixel size of the image may determine the amount of unsharp mask applied.

Furthermore, in an automated environment where diverse image sizes and quality need to be enhanced and/or compressed or recompressed, a ratio of file size in bytes to the total pixel count of an image can be used as a measuring parameter to determine an optimal compression factor so as to retain good visual qualities and achieve a higher degree of compression than that of an original compressed image, e.g. a JPEG. This allows an image processing system to approximate a quality based upon the image's ratio.

In one embodiment, the present invention provides a method of automatically processing a series of input images without operator's intervention. In automatically processing each of the input images, the method includes the steps of providing processing parameters; automatically analyzing, classifying, and enhancing each of the input images without operator's intervention; and outputting at least one enhanced image.

Still in one embodiment, the method outputs more than one enhanced images without re-analyzing, re-classifying, and re-enhancing the input image. The enhanced output images may be in different file types and/or sizes.

Further in one embodiment, the images can be processed in real time on-the-fly or in a batch mode. Further, the images can be processed in a hardware, firmware, or software embodiment that furthermore can be embedded in another system, device, and/or application.

Yet in one embodiment, the method may include one or more of the steps of: pre-processing the input image; automatically resizing the enhanced image; automatically pre-compression enhancing the enhanced image; post-processing the enhanced image; and automatically compressing the enhanced image.

The present invention also provides a method of automatically processing a series of input images without operator's intervention. In automatically processing each of the input images, the method includes the steps of providing processing parameters; automatically analyzing and classifying the input image without operator's intervention; automatically compressing the image; and outputting at least one compressed image.

Still in one embodiment, the method outputs more than one compressed image without re-analyzing and re-classifying the input image. The compressed output images may be in different file types and/or sizes, and/or of different compression ratios, YUV settings, and Q-factor.

Further in one embodiment, the images can be processed in real time on-the-fly or in a batch mode. Further, the images can be processed in an embedded hardware, firmware, or software that can be embedded in another application.

Yet in one embodiment, the method may include one or more of the steps of: pre-processing the input image; resizing the compressed image; pre-compression enhancing the compressed image, post-processing the compressed image; and compressing the compressed image.

The present invention further provides an image processing system of automatically processing a series of input images without operator's intervention. In one embodiment, the system includes an input module for inputting a set of parameters; an image analysis module for automatically analyzing each of the input images, an image classification module for automatically classifying the analyzed image, an image enhancement module for automatically enhancing the classified image based on classification, and an output module for outputting at least one enhanced image.

Still in one embodiment, the output module outputs enhanced images with different file types and/or sizes without re-analyzing, re-classifying, and re-enhancing the input image.

Further in one embodiment, the image processing system processes the images in real time on-the-fly or in a batch mode.

Additionally in one embodiment, the image processing system can be embedded in a hardware, firmware, or software which can be embedded in another system or application.

Yet in one embodiment, the system may include one or more of the following: a pre-processor for pre-processing the input image; a resizer for resizing the enhanced image; a pre-compression enhancement module for pre-compression enhancing the enhanced image; a post-processor for post-processing the enhanced image; and a compression module for automatically compressing the enhanced image.

Additionally in one embodiment, the image analysis module analyzes the image based on an image histogram.

Still in one embodiment, the image classification module classifies the image based on the Weighted Means range, the Weighted Standard Deviation range, and the Halve Value Position range of an image luminosity histogram.

Further in one embodiment, the image enhancement module may include a brightness filter, a contrast filter; a saturation filter; a curve filter; an unsharp mask filter, a blur filter, and/or a hue filter, etc.

Yet in one embodiment, the image compression module includes a JPEG compression.

Still in one embodiment, the image resizer resizes the original input image to any smaller size image proportionately to the original image using any specified axis.

Further in one embodiment, the image resizer resizes the image to a thumbnail size.

Additionally in one embodiment, the image pre-processor includes a brightness filter, a contrast filter, a saturation filter, and/or an unsharp mask filter.

Further in one embodiment, the image post-processor includes a brightness filter, a contrast filter, a saturation filter, and/or an unsharp mask filter.

One aspect of the present invention is that the automatic image processing operations can be manipulated by an operator. For example, an operator can interrupt the automatic image processing operations at any time. The images in the process can be saved in a memory and later restored to continue the operations. For example, if an operator wants to check the quality of the process and/or the quality of a specific image, the images being processed in the operations are saved automatically.

A further aspect of the present invention is that the system and method provide an interactive interface between the system and an operator. For example, the present invention may generate an enhanced image on-the-fly or in real time to allow an operator or user to preview the enhanced image before the system outputs the enhanced image in a given size.

For a better understanding of the invention, reference should be made to the drawings, which form a further part hereof, and to accompanying descriptive matter in which there are illustrated and described specific examples in accordance with the invention.

### BRIEF DESCRIPTION OF THE DRAWINGS

Referring now to the drawings in which like reference numbers represent corresponding parts throughout:

FIG. 1 illustrates one embodiment of an image processing system in accordance with the principles of the present invention.

FIG. 2 illustrates one embodiment of an image processing system having additional optional modules in accordance with the principles of the present invention.

FIG. 3 illustrates another embodiment of an image processing system in accordance with the principles of the present invention.

FIG. 4 illustrates another embodiment of an image processing system having additional optional modules in accordance with the principles of the present invention.

FIGS. 5A-5B illustrate a flow chart diagram of one embodiment of an image processing method in accordance with the principles of the present invention.

FIGS. 6A-6C illustrate a flow chart diagram of image classification/enhancement operations in one embodiment of an image processing method in accordance with the principles of the present invention.

FIGS. 7A-7C are exemplary curves applied to an image in an image enhancement operation in accordance with the principles of the present invention.

### DETAILED DESCRIPTION OF THE PREFERRED EMBODIMENTS

In the following description of the illustrated embodiments, reference is made to the accompanying drawings which form a part hereof, and in which is shown by way of illustration several embodiments in which the invention may be practiced. It is to be understood that other embodiments may be utilized as structural or operational changes and may be made without departing from the spirit and scope of the present invention.

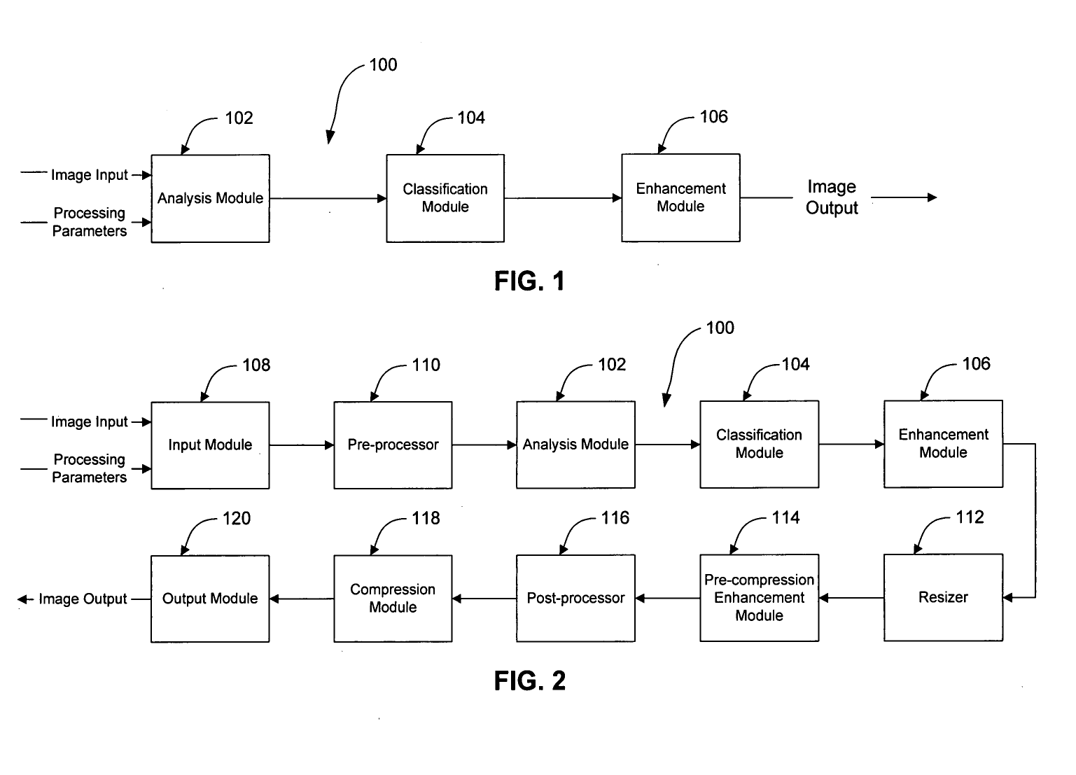

FIG. 1 illustrates one embodiment of an image processing system 100 in accordance with the principles of the present invention. The image processing system 100 includes an image analysis module 102, an image classification module 104, and an image enhancement module 106 wherein each image is automatically analyzed, classified, and enhanced individually based upon each of the characteristics without human intervention when multiple images are submitted for processing. It is noted that the image processing system 100 is capable of processing a single image as well as a series of images.

As shown in FIG. 1, an image or a series of images are input into the image processing system 100. A set of processing parameters are used in the image processing system 100. The processing parameters may include predefined system, device, or operating environment parameters. The predefined system, device, or operating environment parameters may be determined by system resources and transmission bandwidth available or applications that the system is transmitted to or embedded therein, etc. The processing parameters may also include user input parameters. For example, the processing parameters may include the number of output images, the size of the output image that a user desires, and/or a set of image output quality and compression settings, etc. The settings can be made on an individual image basis or specified in a rule set for all images processed until such time as another rule set is applied. The settings may define the methodology for analysis of a file type to achieve the image compression to quality ratio desired. Further, if a user chooses not to define its own settings, a set of default settings may be used.

The input images may be processed in the image processing system 100 in real time on-the-fly or in a batch mode. The image processing system 100 in accordance with the present invention may also be applied to environments such as web-crawling, a program that searches web pages hosted on the Internet to extract images for purpose of enhancing and further compressing of the images in an automated environment.

Additionally in one embodiment, the image processing system can be embedded in a hardware, firmware, or software which can be embedded in another system or application.

Further, the system 100 may be applied in an automated on-the-fly environment for re-purposing and further compressing of images. The re-purposing and further compressing of image allows for transmission of images to diverse devices having different rendering capacity and image type requirements and further reduction of the bandwidth required for transmission of the images and the time required to download the images. The process may be applied to fixed wire or wireless transmission of images to devices. One example is that the system applies to images hosted on the Internet where an image content of an HTML page is further compressed and possibly re-purposed as a black and white image to fit the rendering requirements of a device.

Further, the system may be applied in an automated on-the-fly environment where images are sent to an imaging server via the Internet whereupon the images are processed directly upon receipt or from a temporary storage, stored for retrieval, and/or transmitted to the point of origin or some other defined location. In addition, the system may be applied in an automated on-the-fly or static environment where an image of a rendered HTML page is captured, enhanced, compressed, and/or stored and/or transmitted.

In FIG. 1, the image analysis module 102 analyzes a luminosity histogram associated with a particular image and derives the Weighted Mean (WM), Half Value Position (HVP), and Weighted Standard Deviation (WSD) of the image luminosity histogram. The analyzed image is classified by the image classification module 104 and enhanced by the image enhancement module 106 based on the classification.

In FIG. 2, the image processing system 100 may include an image input module 108, a pre-processor 110, a resizer 112, a pre-compression enhancement module 114, a post-processor 116, a compression module 118, and an output module 120. For example, the resizer 112 may resize an enhanced image to a file size defined by a user, for example, to a thumbnail size (e.g. the longest axis of an image having less than 128 pixels). In another example, the image compression module 118 may include a JPEG compression algorithm to compress an image if desired by the user. It is appreciated that these additional modules may be optional, and that the system 100 is not limited to these optional modules.

The pre-processor 110 and the post-processor 116 may include a set of filters, but not limited to, for adjusting the brightness, contrast, and/or saturation, or applying unsharp mask to the image to enhance the image quality of the processed image. It is noted that the terms for brightness, contrast, saturation, and unsharp mask are known in the image processing art.

The input module 108 sets or preserves a white threshold for an input image and determines whether an input image file has a file extension of jpg, .bmp, or tif, etc. The input module 108 may also load the input image into a memory in a standard format, for example, a Device Independent Bitmap (DIB) format. The input module 108 determines image attributes, such as file type, file size, file dimension, etc., and obtains an image histogram, such as an image luminosity histogram to calculate the Weighted Mean (WM), Half Value Position (HVP), and Weighted Standard Deviation (WSD) of an image.

The output module 120 may save the output image to a storage medium, transmit the output image to a local or remote device, or pass the output image to another application, etc. If more than one images are desired to be outputted—for example, a user desires to have a first enhanced image to be of a regular size and a second enhanced image to be of a thumbnail size—, the system 100 automatically generates the second output image based on the user defined file size after generating the first output image. The system 100 does not need to re-load into memory, re-analyze, re-classify, or re-enhance the original input image. The system 100 processes the additional output images based on the user defined parameters for the additional output images for example resizing, pre-compression enhancement, pre- and post-processing, output file type, and compression after the enhancement module 106.

Further, since the image input, the image analysis, image classification, image enhancement, and the image output can be separable, the system 100 is able to automatically process the subsequent input image in the image analysis module 102, image classification module 104, and image enhancement module 106 while outputting previously enhanced images.

In one embodiment of the present invention, the image analysis module 102 analyzes the input image to determine its unique characteristics, for example, color, black/white (B/W), gray scale, luminosity, contrast, brightness, curve, etc. The analyzed data may be stored in tables, a knowledge based database, or the like.

In one embodiment of the present invention, the image classification module 104 classifies the input image based upon the Weighted Mean (WM), Half Value Position (HVP), and Weighted Standard Deviation (WSD) of the image luminosity histogram. The WM, HVP, and WSD are compared to a predetermined set of parameters for each class of images that are derived from experimental data stored in tables, a knowledge based database, or the like. The experimental data can be a collection of human experienced/perceptive data about images from which tables or a knowledge based is built. Then, a predetermined set of changes may be applied to the image based upon its class.

In one embodiment of the present invention, the image enhancement module 106 provides filters and masks to change the characteristics of the input image such that the image is improved and enhanced for its visual qualities.

In one embodiment of the present invention, the image processing system 100 provides a user interface which allows a user to define an end-product image characteristics, for example, the highest compression, the best compression to quality ratio, a specific or near loss-less image characteristic, etc.

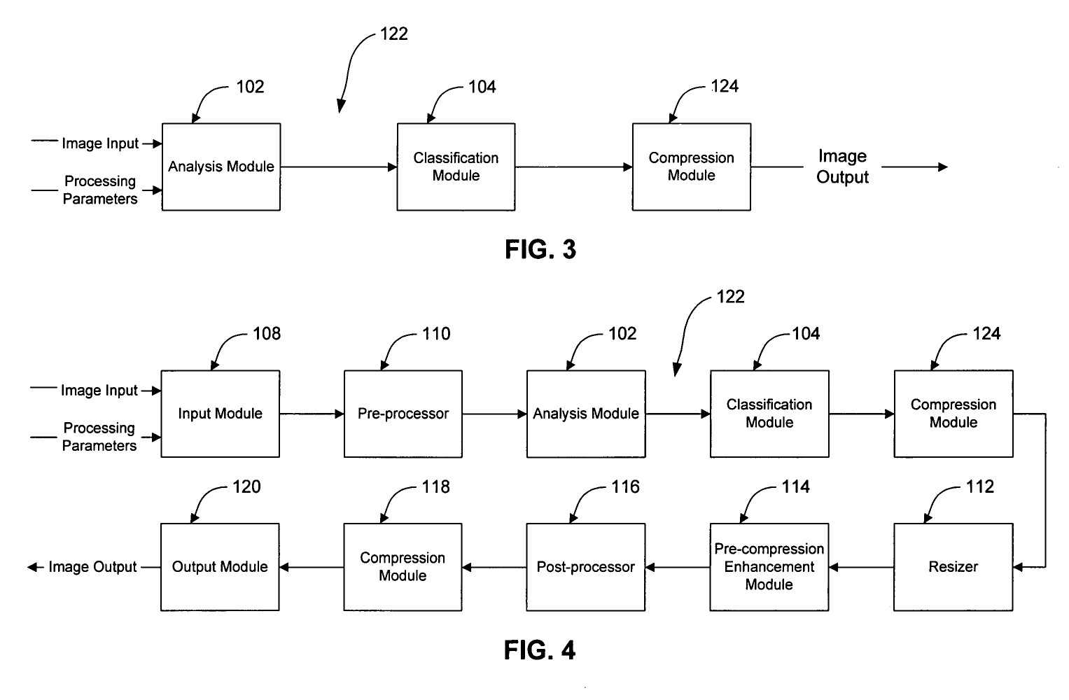

FIG. 3 illustrates another embodiment of the image processing system 122 in accordance with the principles of the present invention. The system 122 includes the analysis module 102, the classification module 104, and a compression module 124. The image is compressed by the compression module 124.

In FIG. 4, the system 122 may further include the image input module 108, the pre-processor 110, the resizer 112, the pre-compression enhancement module 114, the post-processor 116, the compression module 118, and the output module 120. It is appreciated that these additional modules may be optional, and that the system 122 is not limited to these optional modules.

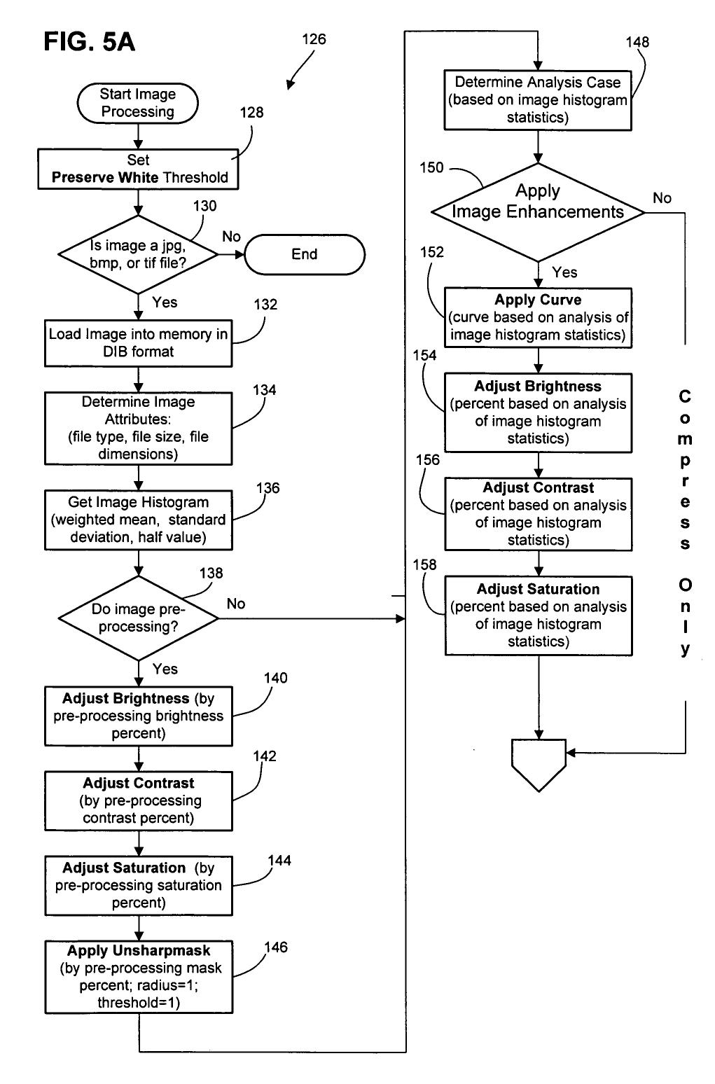

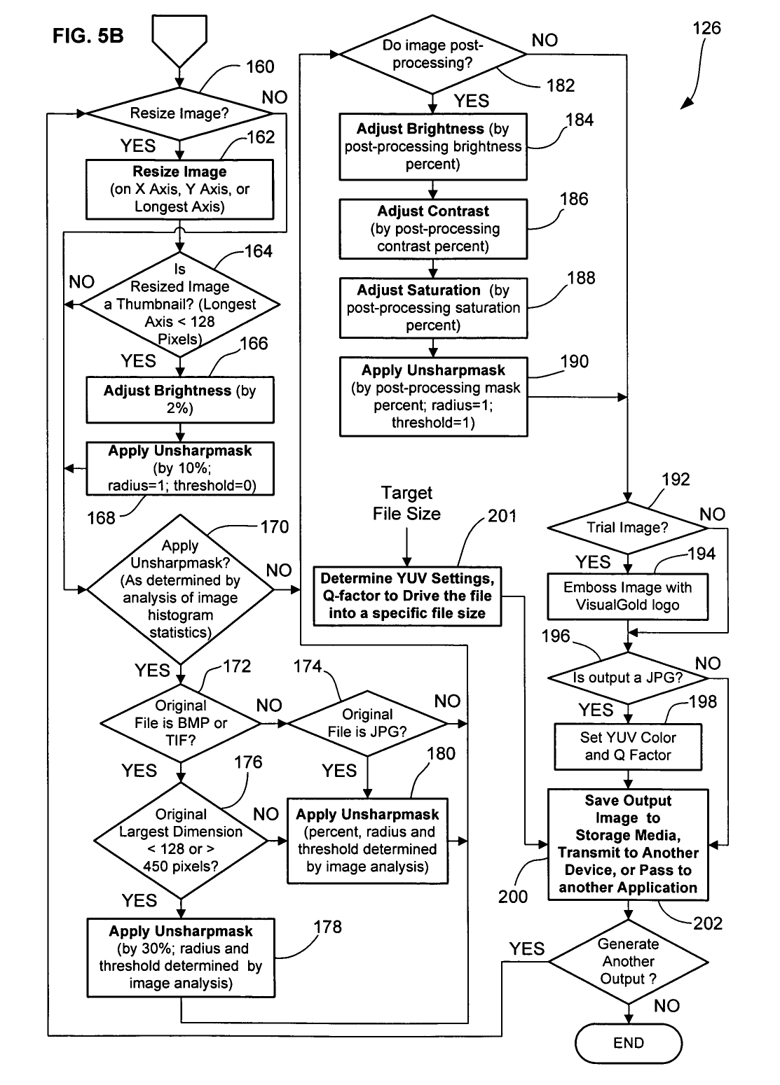

FIGS. 5A-5B illustrate a flow chart diagram of one embodiment of an image processing method in accordance with the principles of the present invention.

As shown in FIG. 5A, an image processing operation flow 126 starts with an operation of setting a preserve white threshold for an input image in an operation 128. In one embodiment, the preserve white threshold may be set to 253-255 out of a gray scale of 0-255. Accordingly, for the portions which have the gray scale of 253 or more, the white is preserved in the subsequent image processing. It is appreciated that a border can be adjusted and/or preserved with a certain gray scale within the scope of the present invention. Then, the operation flow 126 determines whether the input image is a compressed image, such as a JPEG image or an uncompressed image, such as a BMP or TIFF, in an operation 130. In one implementation shown in FIG. 5A, if the input image is not a JPEG, BMP, or TIFF file, the operation flow 126 may be terminated. It is appreciated that the implementation can be varied such that other types of compressed or uncompressed images can be processed without departing from the scope of the present invention.

In FIG. 5A, if the input image is a JPEG, BMP, or TIFF, the image is loaded into a memory or buffer in a standard format, such as a DIB format, in an operation 132. Then, the image attributes, such as file type, file size, and file dimension, are determined in an operation 134 by determining the characteristics of a physical file. It is appreciated that the file type, file size, and file dimension determination is known in the art and not the focus of the present invention. Next, an image luminosity histogram of the input image is generated in an operation 136. The image luminosity histogram may include Weighted Mean (WM), Weighted Standard Deviation (WSD), and Half Value Position (HVP). The details of the WM, WSD, and HVP are described later in details. It is appreciated that the other types of image histograms can be used without departing from the scope of the present invention.

Still in FIG. 5A, the operation flow 126 determines whether a user desires to pre-process the input image in an operation 138. If “Yes”, the brightness, contrast, and saturation percentage of the image may be adjusted based on the user definition in operations 140, 142, and 144, respectively. Further, an unsharp mask may be applied to the image, for example applying a mask percentage of a radius equal to 1 and a threshold equal to 1 in an operation 146. The pre-processing mask percentage can also be defined by the user. It is appreciated that the sequence or order of the operations 140-146 can be varied within the scope of the present invention.

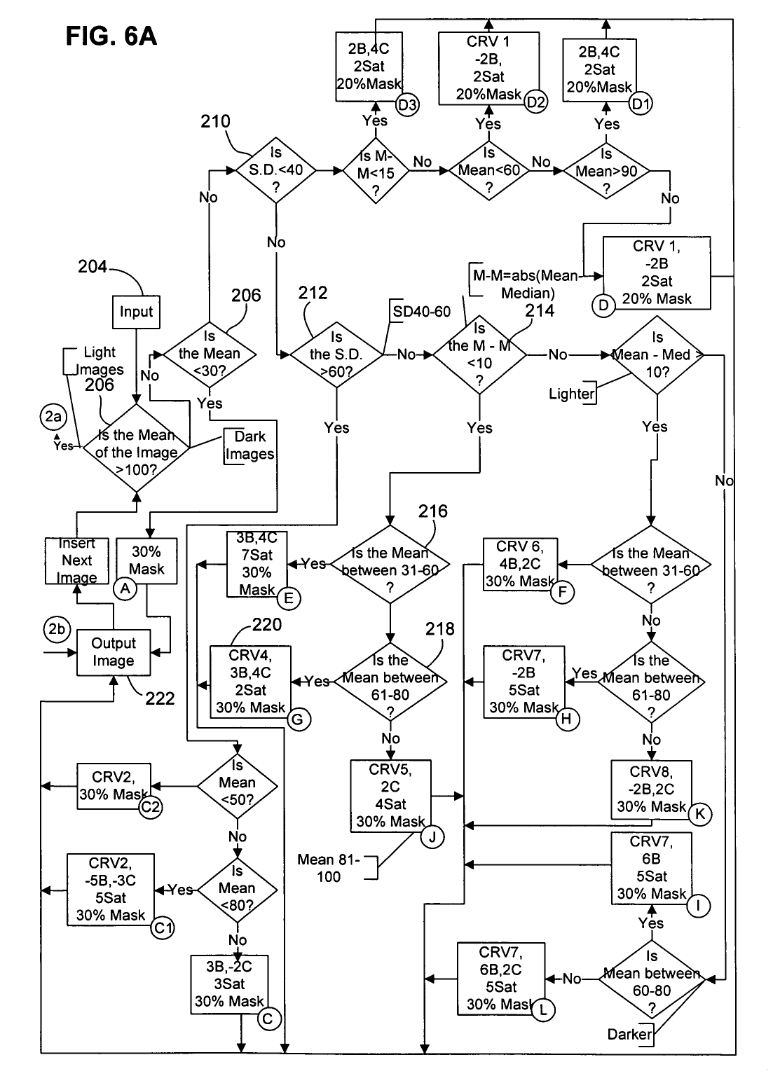

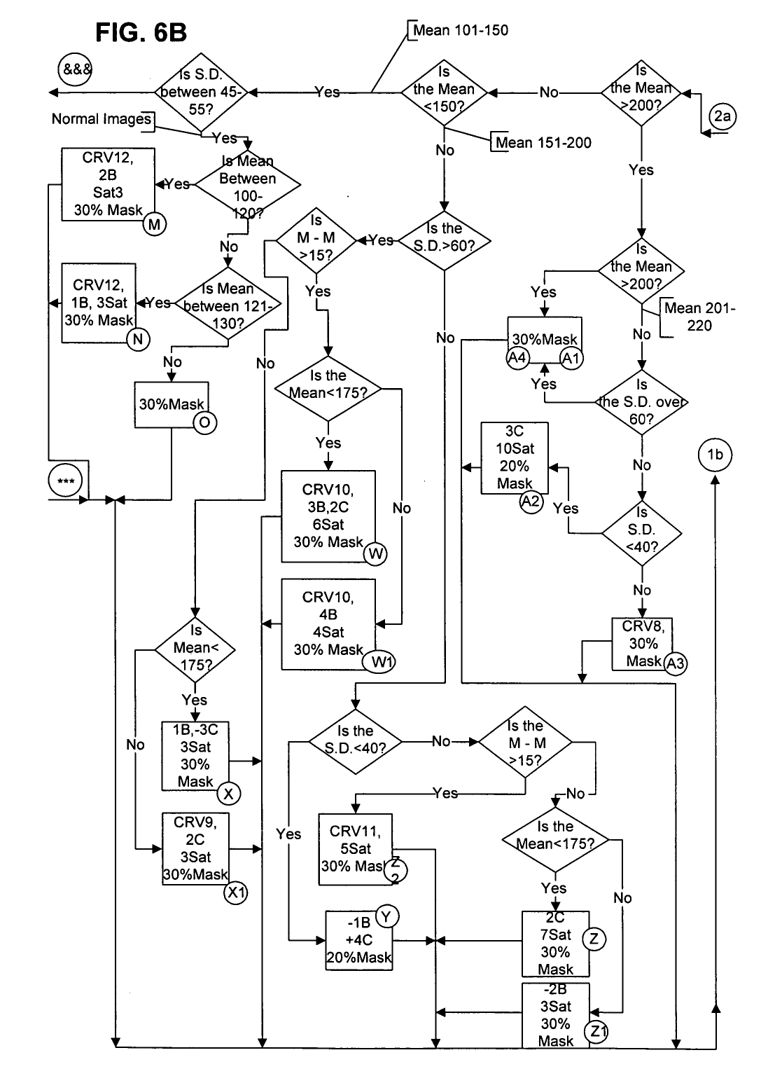

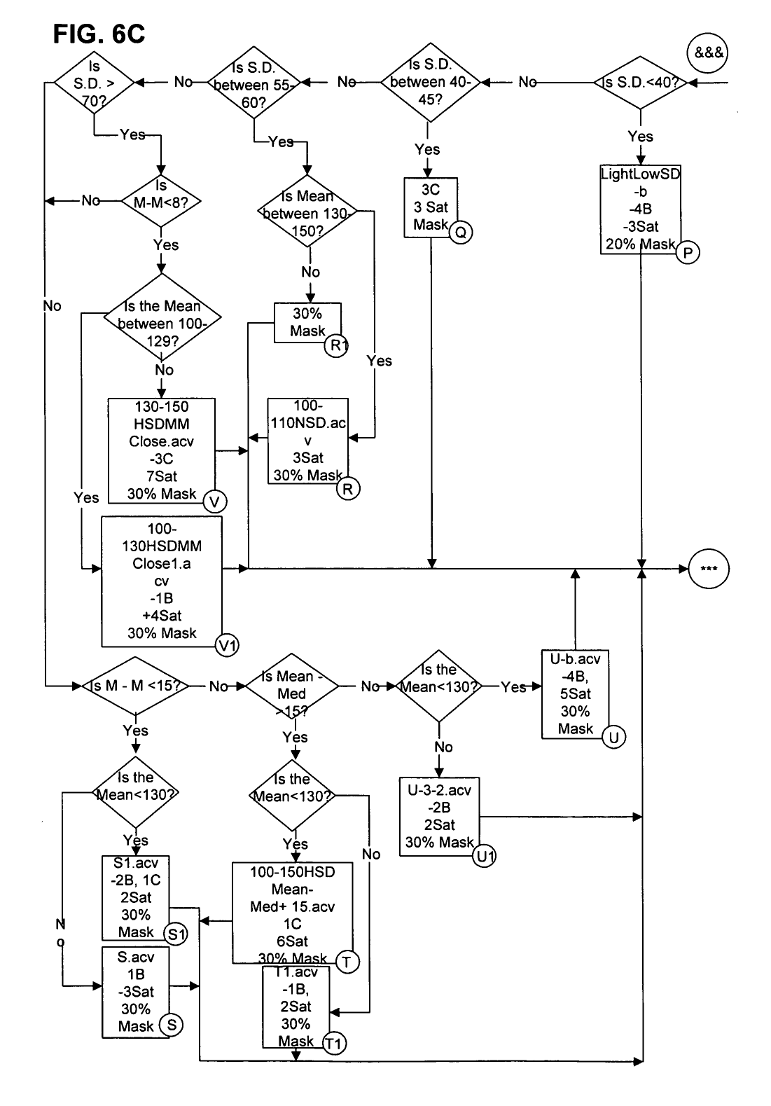

If the image pre-processing is not desired in the operation 138, i.e. “No”, the image is analyzed/classified based on the image histogram statistics in an operation 148. The detailed analysis/classification is described later in FIGS. 6A-6C.

Then, the operation flow 126 determines whether an image enhancement is desired in an operation 150. If “Yes”, a curve is applied based on analysis of the image histogram statistics in an operation 152. Further, the percentage of brightness, contrast, and saturation of the image is adjusted based on the analysis of the image histogram statistics in operations 154, 156, and 158, respectively. It is appreciated that the sequence or order of the operations 152-158 can be varied within the scope of the present invention. Then, the operation flow 126 goes to FIG. 5B. On the other hand, if the image enhancement is not desired in the operation 150, i.e. “No”, then the operations 152-158 are bypassed, and the operation flow 126 goes to FIG. 5B directly.

In FIG. 5B, the operation flow 126 determines whether the user desires to resize the image in an operation 160. If “Yes”, the image is resized along its X axis, Y axis, or the longest axis in an operation 162. Then, the operation flow 126 determines whether the resized image is a thumbnail size image (e.g. the longest axis of the image having less than 128 pixels) in an operation 164. If the resized image is a thumbnail image, i.e. “Yes”, the brightness of the image is adjusted by a predefined percentage, such as 2%, etc. in an operation 166, and an unsharp mask is applied by a predetermined percentage having a predetermined radius and/or threshold, for example, by 10% having a radius of 1 and threshold of 0 in an operation 168.

If the resized image is not a thumbnail size image in the operation 164, i.e. “No”, or if the image is not desired to be resized in the operation 160, i.e. “No”, then the operation flow 126 determines whether an unsharp mask should be applied based on analysis of the image histogram statistics in an operation 170. If an unsharp mask should be applied, i.e.“Yes”, the operation flow 126 determines whether the input image is an uncompressed image, such as a BMP or TIFF image, or the input image is a compressed image, such as a JPEG image in operations 172, 174. If the input image is a BMP or TIFF image, then the operation flow 126 determines whether the largest dimension of the input image is between a range, for example, between but not including 128 and 450 pixels in an operation 176. If the largest dimension of the input image is within 128-450 pixel range, i.e. “Yes”, an unsharp mask is applied by a predetermined percentage in an operation 178, for example, by 30%, which has a radius and threshold based on the image analysis. Next, the operation flow 126 goes to determine whether an image post-processing is desired in an operation 182.

If the largest dimension of the input image is not within 128-450 pixel range in the operation 176, i.e. “No”, or if the input image is a JPEG, BMP, or TIFF image from the operations 172 and 174, then an unsharp mask is applied in an operation 180 by a percentage, radius, and threshold based on the image analysis. Next, the operation flow 126 goes to determine whether an image post-processing is desired in an operation 182.

If the user desires to post-process the image in the operation 182, i.e. “Yes”, the brightness, contrast, and saturation percentage of the image may be adjusted by the user's definition in operations 184, 186, and 188, respectively. Further, an unsharp mask may be applied to the image by post-processing mask percentage, for example, having a radius equal to 1 and a threshold equal to 1 in an operation 190. The post-processing mask percentage can also be defined by the user. It is appreciated that the sequence or order of the operations 184-190 can be varied within the scope of the present invention.

If the post-processing is not desired in the operation 182, i.e. “No”, then the operation flow 126 may determine whether a trial image or a preview of an output image is desired in an operation 192. If a trial image is desired, i.e. “Yes”, then a logo, such as a company's logo, erg. VisualGold™ logo, may be embossed in the trial image in an operation 194. Next, the operation flow 126 goes to determine whether an image output is a JPEG image in an operation 196.

If the trial image is not desired in the operation 194, then the operation flow 126 goes to determine whether an image output is a JPEG image in the operation 196. Also, since each of the processing steps is separable from each other, the operation flow 126 can be interrupted at any time. Once interrupted, the image at the time of interruption is automatically saved for review and further processing.

If the image output is a JPEG image in the operation 196, i.e. “Yes”, then the YUV color settings and Q-factor for the JPEG image are set in an operation 198. The YUV color settings and Q-factor are described later in details. Next, the image output is saved to a storage medium, transmitted to a device, or passed to an application, etc., in an operation 200. If the image output is not a JPEG image in the operation 196, then the operation 198 is bypassed, and the operation flow 126 goes to an operation 200 to save the image output to a storage medium, or to transmit the image output to a device, or to pass the image output to another application, etc.

When a compression is desired to drive an output file to a specific file size, the operation flow 126 further includes an operation 201 to determine YUV settings and Q-factor.

Then, the operation flow 126 goes to determine whether additional image outputs of the same input image are desired in an operation 202. If additional image outputs are not desired, the image processing operation flow 126 is terminated. If additional image outputs are desired, the image processing operation flow 126 goes back to the operation 160 to determine whether the additional image needs to be resized and continues the steps as described above. It is noted that the additional output images are generated without re-analyzing, re-classifying, or re-enhancing/re-compressing the input image.

It is appreciated that additional operations can be implemented within the scope of the present invention. For example, the operation flow 126 may include operations such that the processed image can be sampled and compared to the input image to allow a user to adjust the processing parameters to achieve the desired output images. Accordingly, the image processing method may include steps of establishing the need for further processing, and providing successive filter settings for each consecutive filter pass by a measurable parameter or a change between input image and processed image, and its approximation to a default or user defined parameter. It is noted that a database containing all process information unique to the image characteristics upon which the process draws information for further processing can be provided. Further, it is noted that an archive of pre-processing and post-processing settings for all images previously processed can be provided. All images previously are processed for a given set of user defined characteristics upon which the process draws information for all future image processing to reduce process iterations for desired results.

Exemplary image analysis, classification, and enhancement/compression processes are described herewith in details. Generally, there are three main steps. The first step is to analyze an image's histogram, e.g. luminosity histogram, to derive the three statistical functions, the Weighted Mean, the Half Value Position, and the Weighted Standard Deviation. The second step is to classify the image by its statistical functions which are compared against set parameters for each class of images. The classes of images are derived from experimental data. The experimental data can be a collection of human experienced/perceptive data about images from which tables and a database is built. The third step is to apply a set of predetermined changes to the image based upon its class. The changes for each class vary but generally include brightness, contrast, saturation, curve, and unsharp mask. It is appreciated that the changes may be applied in a specific degree and order, and that the application of the changes may also take into account for the compression that may be applied after this process and/or other processes such as resizing of an image.

I. Analysis of An Input Image

In general, an input image is converted to a standard format, for example, a DIB format, to improve visual qualities of the input image. Each image is then analyzed for its unique luminosity and color characteristics/attributes, classified, and enhanced to improve its visual qualities. The method includes all interfaces and logic to operate in a dynamic environment or a static environment as part of an application or as a stand-alone utility. The input image can be a pre-compressed image via a compression algorithm, such as JPEG, Wavelet, and Fractal, etc. The input image can also be an uncompressed image, such as a BMP or TIFF image.

Analysis of both statistical and visual qualities of the images may produce the following results. For example, images can be divided into classes based upon distinctions in images' luminosity histogram: a) the Weighted Mean (WM); b) the Weighted Standard Deviation (WSD); and c) the direction and amount of separation between the Weighted Mean and the Half Value Position (HVP), etc.

By analyzing each component, the following results may occur: a) the higher the Weighted Mean, the lighter the image color; it is noted that this may be the main determining criteria for image classification; b) the higher the Standard Deviation, the higher the contrast of the image; c) depending on the Weighted Mean and Standard Deviation, the difference between the Weighted Mean and the Half Value Position determines the exposure of an image. For example, an image with a higher Standard Deviation, a greater difference in Half Value Position, and a lesser Weighted Mean, results in an over-exposed image. While images that possess these values within a certain constraint are considered as images of “normal” exposure. This generally forms the basis for the analysis, classification, and identification of the required enhancements to be performed on the image.

The analysis of the image histogram is derived from the three statistical functions as defined below:
1) Weighted Mean:

$$\frac{{\sum }_{i = 0}^{255} {a}_{i} {p}_{i}}{{\sum }_{j = 0}^{255} {a}_{j}}$$

2) Weighted Standard Deviation:

$$\sqrt{( {\sum }_{i = 0}^{255} ( ( \frac{{a}_{i}}{{\sum }_{j = 0}^{255} {a}_{j}} ) {( {p}_{i} - \frac{{\sum }_{k = 0}^{255} {a}_{k} {p}_{k}}{{\sum }_{l = 0}^{255} {a}_{l}} )}^{2} ) )}$$

Where pₙ is defined as the position or ordinal values of the histogram, and aₙ is defined as the amplitude of the pixels at each n^{th} ordinal.

3) Half Value Position: This is defined as the ordinal in the Histogram where all the pixels below that ordinal, sum (left to right) to at least half the pixels of the image.

It is appreciated that the definitions of the above three functions may be varied within the scope of the present invention.

II. Classification and Enhancement Application Based on Classification

The results of the analysis of the image histogram are used to classify and enhance the image.

TABLE 1 below defines a rule set for classifying an image and an enhancement rule set for each classification of images. It is appreciated that TABLE 1 is an exemplary illustration of qualitative analysis and can be varied within the scope of the present invention. Therefore, TABLE 1 is considered as one embodiment of the present invention, and the invention is not limited thereby.

TABLE 1

| Operation Identification | | |
|---|---|---|
| Shown in FIGS. 6A-6C | Classification Rules | Enhancement Rules* |
| A | WM < 30 | Mask |
| D1 | 30 ≦ WM < 100 | 2B, 4C, 2Sat |
| | WSD < 40 | 20% Mask |
| | \|WM − HV\| < 15 | |
| D2 | 30 ≦ WM < 60 | CRV1 |
| | WSD < 40 | −2B, 2Sat |
| | \|WM − HV\| > 15 | 20% Mask |
| D3 | 60 ≦ WM < 90 | 2B, 4C, 2Sat |
| | WSD < 40 | 20% Mask |
| | \|WM − HV\| > 15 | |
| D | 90 ≦ WM < 100 | CRV1 |
| | WSD < 40 | −2B, 2Sat |
| | \|WM − HV\| > 15 | 20% Mask |
| C2 | 30 ≦ WM < 50 | CRV2 |
| | WSD > 60 | 30% Mask |
| C1 | 50 ≦ WM < 80 | CRV3 |
| | WSD > 60 | −5B, −3C, 5Sat |
| | | 30% Mask |
| C | 80 * WM < 100 | 3B, −2C, 3Sat |
| | WSD > 60 | 30% Mask |
| E | 30 ≦ WM < 60 | 3B, 4C, 7Sat |
| | 40 ≦ WSD ≦ 60 | 30% Mask |
| | \|WM − HV\| < 10 | |
| G | 60 ≦ WM < 80 | CRV4 |
| | 40 ≦ WSD ≦ 60 | 3B, 4C, 2Sat |
| | \|WM − HV\| < 10 | 30% Mask |
| J | 80 ≦ WM < 100 | CRV5 |
| | 40 ≦ WSD ≦ 60 | 2C, 4Sat |
| | \|WM − HV\| ≦ 10 | 30% Mask |
| F | 30 ≦ WM < 60 | CRV6 |
| | 40 ≦ WSD ≦ 60 | 4B, 2C |
| | WM − HV > 10 | 30% Mask |
| H | 60 ≦ WM < 80 | CRV7 |
| | 40 ≦ WSD ≦ 60 | −2B, 5Sat |
| | WM − HV > 10 | 30% Mask |
| K | 80 ≦ WM < 100 | CRV8 |
| | 40 ≦ WSD ≦ 60 | −2B, 2C |
| | WM − HV > 10 | 30% Mask |
| I | 60 ≦ WM < 80 | CRV7 |
| | 40 ≦ WSD ≦ 60 | 6B, 5Sat |
| | HV − WM > 10 | 30% Mask |
| L | 80 ≦ WM < 100 | CRV7 |
| | 40 ≦ WSD ≦ 60 | 6B, 2C, 5Sat |
| | HV − WM > 10 | 30% Mask |
| A4 | WM > 220 | 30% Mask |
| A1 | 200 < WM ≦ 220 | 30% Mask |
| | WSD > 60 | |
| A2 | 200 < WM ≦ 220 | 3C, 10Sat |
| | WSD < 40 | 20% Mask |
| A3 | 200 < WM ≦ 220 | CRV8 |
| | 40 ≦ WSD ≦ 60 | 30% Mask |
| X | 150 < WM ≦ 175 | 1B, −3C, 3Sat |
| | WSD > 60 | 30% Mask |
| | \|WM − HV\| ≦ 15 | |
| X1 | 175 < WM ≦ 200 | CRV9 |
| | WSD > 60 | 2C, 3Sat |
| | \|WM − HV\| ≦ 15 | 30% Mask |
| W | 150 < WM ≦ 175 | CRV10 |
| | WSD > 60 | 3B, 2C, 6Sat |
| | \|WM − HV\| > 15 | 30% Mask |
| W1 | 175 < WM ≦ 200 | CRV10 |
| | WSD > 60 | 4B, 4Sat |
| | \|WM − HV\| > 15 | 30% Mask |
| Y | 150 < WM ≦ 200 | −1B, 4C |
| | WSD < 40 | 30% Mask |
| Z2 | 150 < WM ≦ 200 | CRV11 |
| | 40 ≦ WSD ≦ 60 | 2C, 5Sat |
| | \|WM − HV\| > 15 | 30% Mask |
| Z | 150 < WM ≦ 175 | 2C, 4Sat |
| | 40 ≦ WSD ≦ 60 | 22% Mask |
| | \|WM − HV\| < 15 | |
| Z1 | 175 < WM ≦ 200 | −2B, 3Sat |
| | 40 ≦ WSD ≦ 60 | 30% Mask |
| | \|WM − HV\| < 15 | |
| M | 100 ≦ WM ≦ 120 | CRV12 |
| | 45 ≦ WSD ≦ 55 | 2B, 5Sat |
| | 30% Mask | 30% Mask |
| N | 120 < WM ≦ 130 | CRV12 |
| | 45 ≦ WSD ≦ 55 | 1B, 3Sat |
| | | 30% Mask |
| O | 130 < WM ≦ 150 | 30% Mask |
| | 45 ≦ WSD ≦ 55 | |
| P | 100 ≦ WM ≦ 150 | CRV13 |
| | WSD < 40 | −4B, −3Sat |
| | | 20% Mask |
| Q | 100 ≦ WM ≦ 150 | 3C, 3Sat |
| | 40 ≦ WSD < 45 | 20% Mask |
| R1 | 100 < WM ≦ 130 | 30% Mask |
| | 55 < WSD ≦ 60 | |
| R | 130 < WM ≦ 150 | CRV12 |
| | 55 < WSD ≦ 60 | 3Sat |
| | | 30% Mask |
| V1 | 100 ≦ WM < 130 | CRV14 |
| | WSD > 70 | −1B, 4Sat |
| | \|WM − HV\| < 8 | 30% Mask |
| V | 130 ≦ WM < 150 | CRV15 |
| | WSD > 70 | −3C, 7Sat |
| | \|WM − HV\| < 8 | 30% Mask |
| S1 | 100 ≦ WM < 130 | CRV16 |
| | WSD > 60 | −2B, 1C, 2Sat |
| | \|WM − HV\| < 15 | 30% Mask |
| S | 130 ≦ WM ≦ 150 | CRV17 |
| | WSD > 60 | 1B, −3Sat |
| | \|WM − HV\| < 15 | 30% Mask |
| T | 100 ≦ WM ≦ 130 | CRV18 |
| | WSD > 60 | 1C, 6Sat |
| | WM − HV > 15 | 30% Mask |
| T1 | 130 ≦ WM ≦ 150 | CRV19 |
| | WSD > 60 | −1B, 2Sat |
| | HV − WM > 15 | 30% Mask |
| U | 100 ≦ WM < 130 | CRV20 |
| | WSD > 60 | −4B, 5Sat |
| | HV − WM > 15 | 30% Mask |
| U1 | 130 ≦ WM ≦ 150 | CRV21 |
| | WSD > 60 | −2B, 2Sat |
| | WM − HV > 15 | 30% Mask |

KEYS FOR TABLE 1
WM = Weighted Mean
B = Brightness
HV = Half Value Position
C = Contrast
WSD = Weighted Standard Deviation
Sat = Saturation
CRV = curves
Mask = BMP/TIFF Unsharp Mask

FIGS. 6A-6C illustrate a flow diagram of image classification/enhancement operations in one embodiment of an image processing method in accordance with the principles of the present invention. The image enhancement operations or rules shown in FIGS. 6A-6C correspond to TABLE 1. For example, an image having the statistics in TABLE 1A below would apply image enhancement rule “G” in FIG. 6A, following operational blocks 204-222. The order in which the enhancement functions are specified in the rule set is one implementation of present invention. It is appreciated that the other orders can be used without departing from the present invention.

TABLE 1A

| Weighted Mean | Weighted Standard Deviation | Half Value Position |
|---|---|---|
| 66.3 | 45.9 | 72 |

It is appreciated that other classification/enhancement rules can be used without departing from the scope of the invention. It is also appreciated that the above classification/enhancement rules may be implemented in an algorithm format within the scope of the invention.

It is appreciated that the other image processing operations such as sharpening, masking, etc., can be used within the scope of the present invention. It is also appreciated that the degree of adjustment in brightness, contrast, saturation, or the percentage or amount of curve, unsharp mask, etc., can be varied without departing from the scope of the present invention.

Exemplary image processing filters or tools that can be used in the present invention are Brightness, Contrast, Saturation, Curves, Unsharp Mark, Preserve White, Resizing, etc.

It is appreciated that the image processing filters are not limited to the above, and that the other filters can be used, such as color balance, tone balance, and/or hue, cropping, etc.

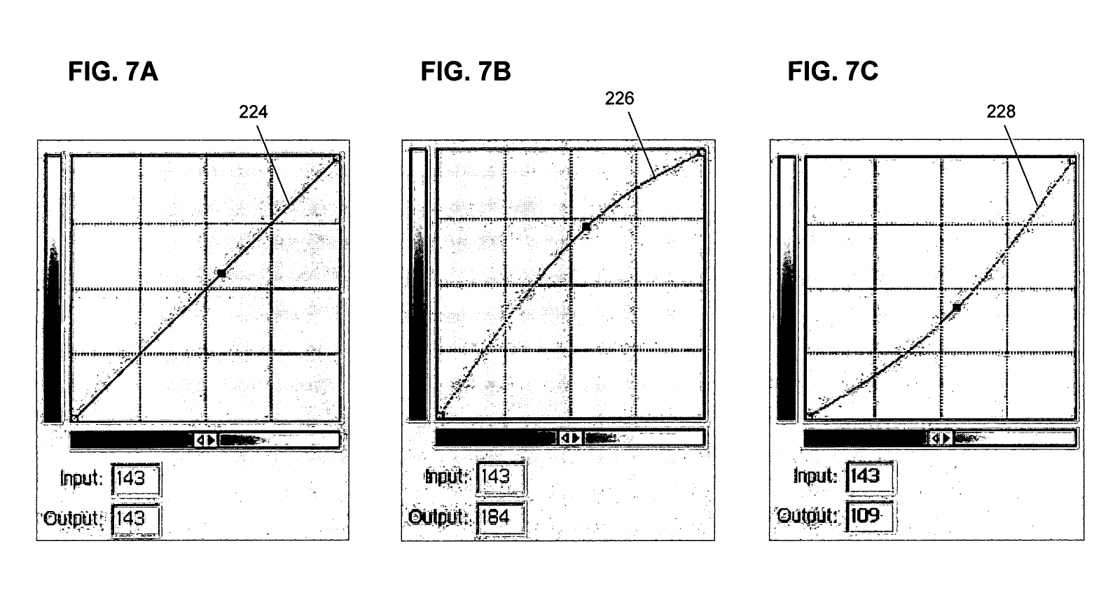

FIGS. 7A-7C illustrate exemplary curves. As described above, curves allow enhancement of luminosity characteristics in a given area of an image when determined by the classification process. The curves enhancement function is defined as a re-mapping of luminosity or density values versus exposure. The benefit of this function occurs when an image needs a shift in luminosity for specific portions in the image. For example, images with shadows are able to shift those shadows to a higher luminosity while the entire image is not shifted or made lighter. The way of achieving this technique involves a mapping of luminosity values which are valued from 0-255 to new luminosity values in that range. The curve applied to an image is determined by the classification of the image. Three exemplary curves applied to map the luminosity values of an input image are shown in FIGS. 7A-7C, respectively. In FIGS. 7A-7C, the line starts in the lower left, i.e. at black color (luminosity level of 0) and goes to the upper right, i.e. at white color (luminosity level of 255). In FIG. 7A, a curve 224 demonstrates no alteration or mapping to an image. For example, an input luminosity level of 143 remains at 143. In FIG. 7B, a curve 226 is applied to brighten the entire image. For example, an input luminosity level of 143 is brightened to luminosity level of 184. In FIG. 7C, a curve 228 is applied to darken the over-all image. For example, an input luminosity level of 143 is darkened to luminosity level of 109. It is noted that in FIGS. 7B and 7C, an entire image is brightened or darkened. It is appreciated that a curve can be applied to brighten or darken a certain portion of the image. It is also appreciated that other curves can be used within the scope of the invention.

To further illustrate a curve in a table format, TABLE 2 provides one exemplary curve for luminosity mapping.

TABLE 2
Curves Table Example
Curves Table Example

| | | | | | | | | |
|---|---|---|---|---|---|---|---|---|
| 255 | 254 | 253 | 252 | 251 | 250 | 249 | 248 | 247 |
| 255 | 253 | 251 | 249 | 248 | 246 | 244 | 242 | 241 |
| 246 | 245 | 244 | 243 | 242 | 241 | 240 | 239 | 238 |
| 239 | 237 | 235 | 234 | 232 | 231 | 229 | 228 | 226 |
| 237 | 236 | 235 | 234 | 233 | 232 | 231 | 230 | 229 |
| 225 | 223 | 222 | 221 | 220 | 219 | 218 | 217 | 216 |
| 228 | 227 | 226 | 225 | 224 | 223 | 222 | 221 | 220 |
| 215 | 214 | 213 | 212 | 211 | 210 | 209 | 208 | 207 |
| 219 | 218 | 217 | 216 | 215 | 214 | 213 | 212 | 211 |
| 207 | 206 | 205 | 205 | 204 | 203 | 203 | 202 | 201 |
| 210 | 209 | 208 | 207 | 206 | 205 | 204 | 203 | 202 |
| 201 | 200 | 200 | 199 | 199 | 198 | 198 | 197 | 197 |
| 201 | 200 | 199 | 198 | 197 | 196 | 195 | 194 | 193 |
| 196 | 196 | 195 | 195 | 194 | 194 | 193 | 193 | 192 |
| 192 | 191 | 190 | 189 | 188 | 187 | 186 | 185 | 184 |
| 192 | 191 | 190 | 189 | 189 | 188 | 187 | 186 | 186 |
| 183 | 182 | 181 | 180 | 179 | 178 | 177 | 176 | 175 |
| 185 | 184 | 183 | 183 | 182 | 181 | 180 | 180 | 179 |
| 174 | 173 | 172 | 171 | 170 | 169 | 168 | 167 | 166 |
| 178 | 177 | 176 | 175 | 174 | 173 | 172 | 171 | 170 |
| 165 | 164 | 163 | 162 | 161 | 160 | 159 | 158 | 157 |
| 169 | 168 | 167 | 166 | 165 | 164 | 163 | 162 | 162 |
| 156 | 155 | 154 | 153 | 152 | 151 | 150 | 149 | 148 |
| 160 | 159 | 158 | 157 | 156 | 155 | 154 | 153 | 152 |
| 147 | 146 | 145 | 144 | 143 | 142 | 141 | 140 | 139 |
| 151 | 149 | 148 | 147 | 146 | 145 | 144 | 143 | 142 |
| 138 | 137 | 136 | 135 | 134 | 133 | 132 | 131 | 130 |
| 141 | 140 | 138 | 137 | 136 | 135 | 134 | 133 | 132 |
| 129 | 128 | 127 | 126 | 125 | 124 | 123 | 122 | 121 |
| 131 | 130 | 129 | 127 | 126 | 125 | 124 | 123 | 122 |
| 120 | 119 | 118 | 117 | 116 | 115 | 114 | 113 | 112 |
| 121 | 120 | 119 | 117 | 116 | 115 | 114 | 113 | 112 |
| 111 | 110 | 109 | 108 | 107 | 106 | 105 | 104 | 103 |
| 111 | 110 | 109 | 107 | 106 | 105 | 104 | 103 | 102 |
| 102 | 101 | 100 | 99 | 98 | 97 | 96 | 95 | 94 |
| 101 | 100 | 99 | 98 | 97 | 96 | 95 | 94 | 93 |
| 93 | 92 | 91 | 90 | 89 | 88 | 87 | 86 | 85 |
| 92 | 91 | 90 | 89 | 88 | 87 | 86 | 85 | 84 |
| 84 | 83 | 82 | 81 | 80 | 79 | 78 | 77 | 76 |
| 83 | 82 | 81 | 80 | 79 | 78 | 77 | 76 | 75 |
| 75 | 74 | 73 | 72 | 71 | 70 | 69 | 68 | 67 |
| 74 | 73 | 72 | 71 | 71 | 70 | 69 | 68 | 68 |
| 66 | 65 | 64 | 63 | 62 | 61 | 60 | 59 | 58 |
| 67 | 66 | 65 | 65 | 64 | 63 | 62 | 62 | 61 |
| 57 | 56 | 55 | 54 | 53 | 52 | 51 | 50 | 49 |
| 60 | 59 | 59 | 58 | 57 | 56 | 56 | 55 | 54 |
| 48 | 47 | 46 | 45 | 44 | 43 | 42 | 41 | 40 |
| 53 | 53 | 52 | 51 | 50 | 50 | 49 | 48 | 47 |
| 39 | 38 | 37 | 36 | 35 | 34 | 33 | 32 | 31 |
| 46 | 46 | 45 | 44 | 43 | 42 | 42 | 41 | 40 |
| 30 | 29 | 28 | 27 | 26 | 25 | 24 | 23 | 22 |
| 39 | 38 | 37 | 36 | 35 | 34 | 33 | 33 | 31 |
| 21 | 20 | 19 | 18 | 17 | 16 | 15 | 14 | 13 |
| 30 | 28 | 27 | 25 | 24 | 23 | 21 | 20 | 18 |
| 12 | 11 | 10 | 9 | 8 | 7 | 6 | 5 | 4 |
| 17 | 16 | 14 | 13 | 11 | 10 | 8 | 7 | 5 |
| 3 | 2 | 1 | 0 | | | | | |
| 4 | 2 | 1 | 0 | | | | | |

Further, an unsharp mask enhances an image by making it sharper without accentuating small imperfections in an image. Thus, an image gains more details and clarity while preserving visual continuity. The unsharp mask percentage applied to an image is dependent upon an input image file type and is handled differently for a compressed image, such as a JPEG image, from an uncompressed image, such as a BMP or TIFF image.

Pre-compression Enhancement Process for Images that are Resized

The image processing system in accordance with the present invention addresses issues of image quality degradation resulting from either resizing of an image or artifacts introduced in the process of compressing a previously compressed image, or a combination of both processes.

Post Resizing Enhancement Process

High quality digital source images, such as BMP and TIFF files that have not been previously compressed, may need to be resized. If the image is resized by dividing the pixel dimensions by some number that, when divided into the number of pixels leaves no fraction, then the sharpness of the image is not significantly degraded in the process. For example, reducing 400 pixels to 200 pixels or 900 pixels to 300 pixels would not greatly alter the apparent sharpness of the image. If the image is resized by another factor such as 400 pixels to 299 pixels, significant interpolation of the image occurs resulting in the loss of image sharpness or clarity. The loss of sharpness generated from this interpolation process can be significantly regained by increasing the edge definition of the image content through application of an unsharp mask filter. The percentage strength of the mask can be altered to optimize the amount of edge enhancement applied based on the ratio of reduction from the original image, the absolute physical dimensions of the reduced image, the amount of interpolation required to achieve the desired resized dimensions, the type of interpolation algorithm used, or a combination of all of the above factors.

TABLE 3 below defines an exemplary unsharp mask applied to a resized image, which is not previously compressed, based on the image's longest axis dimension.

TABLE 3
(BMP & TIFF unsharp mask)
MASK TABLE FOR BMP & TIFF IMAGES

| DPI | Mask % to be applied |
|---|---|
| 0 to 128 | 30 |
| 128 to 450 | 35 |
| 450+ | 30 |

The enhancement process also considers the special case of thumbnails, e.g. images of approximately 128 pixels or less on the longest axis, wherein the information defining the image is significantly reduced. Image sharpness of thumbnail-sized images is greatly improved by applying an additional percentage of unsharp mask, and a small increase in contrast, brightness, and, for color images, saturation. These filters allow the image to retain high visual qualities while attaining higher degrees of compression than when not applying such filters.

It is appreciated that the enhancement process is not limited to the special case of thumbnails, and that the enhancement process can be used in other resizing applications within the scope of the present invention.

Enhancement Process for Resizing Previously Compressed Images

The rules that govern usage of an unsharp mask applied to an input image previously compressed, such as a JPEG image, require different unsharp mask optimization rules from those applied to images that have not been previously compressed.

The percent of unsharp mask to be applied in the resizing of a previously compressed JPEG image requires compensating for the variables described as optimal for uncompressed images and, in most cases, the percentage of the unsharp mask is then reduced from that uncompressed optimal setting so as not to accentuate the artifacts introduced in the initial compression process.

Determining the factor to reduce the amount of mask for a given JPEG file can be calculated in several ways. In one method, the ratio of total pixel count of the DIB (Device Independent Bitmap) is compared with the original compressed JPEG image file size in kilobytes. This ratio is used as criteria for exemplary TABLE 4 below to obtain the appropriate unsharp mask percentage to be applied to the image.

TABLE 4
MASK TABLE FOR JPEG IMAGES
Ratio is the total pixels of an image divided by the file size (K)

| Ratio | Mask % to be applied |
|---|---|
| 0-1500 | 42 |
| 1501-1900 | 36 |
| 1901-2300 | 26 |
| 2301-2600 | 23 |
| 2601-3500 | 20 |
| 3501-4500 | 17 |
| 4501-6000 | 15 |
| 6001-9000 | 10 |
| 9001-12000 | 7 |
| 12001+ | 5 |

The application of the use of an unsharp mask in this fashion enhances edge definition and, therefore, apparent sharpness to the image without adding significantly to the picture's high frequency content. Since high frequency limits how effectively a compression algorithm can be in reducing file size, images processed in this manner can be compressed further, with less visible artifacts, high apparent image sharpness, and greatly reduced file size.

The pre-compression, post resizing enhancement is applied automatically without operator's intervention. The algorithm can also be applied in a networked or server-based environment where no human intervention is possible.

Enhancement Process for Reducing Apparent Artifacts in Images

An image may have had artifacts introduced into the picture or image through a scanning process, compression algorithm, color reduction such as experienced in a GIF image for the Internet or by scanning a printed page including half-tone dot patterns. The present invention reduces these visible artifacts and allows for the creation of a second-generation image that can be resized and compressed with improved edge definition and reduced artifacts as compared with the source image.

The process utilizes a “Blur” filter that tends to “smear/smudge” the blocking generated as a result of the compression or similar to a blocking of dot patterns created by scanned images or GIF. Because the “Blur” filter reduces the appearance of the blocking throughout the whole picture, edge definition of the image degrades and thus must be restored. The application of unsharp mask filter is then applied in multiple iterations in same or varying amounts (e.g. 15%/15%/15%) whereupon the image's intended edges are redefined with the artifacts remaining less evident.

It is appreciated that other filters may be applied to pre-compression, post-resizing enhancing of images without departing from the scope of the present invention. It is further appreciated that the degree of application of the filters applied, e.g. “Blur”, “unsharp mask”, etc., can be varied without departing from the scope of the present invention.

III. Compression of the Output Image

The image processing system may include a user interface that allows a user to compress an enhanced image. As an example, an enhanced JPEG image can be further compressed by setting YUV settings and Q-factor, as well as a unique file name for each output image when applied to a batch of images.

It is appreciated to those skilled in the art that the Q-Factor relates to a term that represents the quality versus compression ratio used in saving an image as a JPEG file. It is also appreciated to those skilled in the art that a YUV Color Difference Coordinate System relates to a color coordinate system that represents RGB colors in terms of the luminosity Y and two difference colors. The Y tristimulus value represents luminosity, while the U and V variables represent a percentage of luminosity less Blue and Red, respectively. It is appreciated that the compression applied is not limited to the compressed JPEG image, without departing from the scope of the present invention.

IV. Compression of an Image to a Target File Size

The image processing system includes a user interface that allows a user to drive an input image to an approximate file size. In one embodiment of the present invention, this may be accomplished with a series of tables. This feature involves saving an input image in a memory or buffer as a 30 Q-factor/4:4:4 YUV setting. The file size (in kilobytes) is then compared against a file size, such as a BMP file size, of an input image to obtain a percentage. This percentage is referenced and used to map to the correct table. An example of these tables is given in a JPEG Compression Approximation in TABLE 5. Of course, those skilled in the art appreciate that many examples of such tables may be provided, and that TABLE 5 is but one of such examples. Accordingly, the invention is not limited to such examples as others may be provided without departing from the scope and spirit of the invention.

TABLE 5

| YUV | | | QFactor | QFactor | QFactor | QFactor | QFactor | QFactor | QFactor |
|---|---|---|---|---|---|---|---|---|---|
| Setting | QFactor 2 | QFactor 5 | 10 | 15 | 20 | 25 | 30 | 35 | 40 |
| 411 | 2.47 | 1.98 | 1.65 | 1.36 | 1.2 | 1.07 | 1 | 0 | 0.856 |
| 422 | 2.695 | 2.075 | 1.675 | 1.38 | 1.21 | 1.075 | 1 | 0.925 | 0.867 |
| 444 | 2.92 | 2.17 | 1.7 | 1.4 | 1.22 | 1.08 | 1 | 0.93 | 0.878 |

An exemplary process of compressing an image on a single image input basis is as follows:
1. Saving the image (enhanced or not) as a 30 Q factor JPEG, 444 JPEG to a memory or buffer, recording the file size of this image, and using it as a reference.
2. Multiplying this file size by the factors dependent upon the YUV setting chosen by the user.
3. Depending upon the file size chosen, the appropriate Q-Factor is applied to the image in order to output the image as a JPEG image.

Accordingly, the user interface allows for various compression and/or quality change settings. Any known compression algorithm, such as the JPEG compression algorithm, can be used within the scope of the invention. In one embodiment, the first user option is a series of compression choices that involve either a slider bar or a set of numerical options. The user interface allows for image compression ranging from, for example, 20 to 60 in Q-Factor while utilizing a 4:1:1 YUV setting.

The image compression range, for example, from 20 to 60 in Q-Factor while utilizing a 4:1:1 YUV setting, is imposed to limit the degradation of images that normally occurs beyond a 60 Q-Factor. For example, a 4:1:1 YUV setting causes a need for an additional +5 saturation to compensate for the color change in an image. The user interface also allows for a separate quality choice. This gives the user the option to compress an image while still being assured a high quality image. In another example, the Q-Factor ranges from 2 to 30 and involves a YUV setting of 4:4:4, which may not require any additional saturation.

The above specification, examples and data provide a complete and enabling description of the invention. Since many embodiments of the invention can be made without departing from the spirit and scope of the invention, the invention resides in the claims hereinafter appended.

1. A method of automatically processing a series of input images without operator's intervention, in automatically processing each of the input images, the method comprising:
providing processing parameters;
automatically analyzing, classifying, and enhancing the input image without operator's intervention; and
outputting at least one enhanced image.

2. The method of claim 1, further comprising outputting a plurality of enhanced images with different file types or file sizes without re-analyzing, re-classifying, and re-enhancing the input image.

3. (canceled)

4. The method of claim 1, wherein the input images are processed in real time on-the-fly or in a batch mode.

5.-8. (canceled)

9. The method of claim 1, wherein the step of automatically analyzing, classifying, and enhancing the input image includes applying an individual image enhancement independently to each of the input images.

10. (canceled)

11. The method of claim 1, further comprising resizing the enhanced image.

12. The method of claim 1, further comprising compressing the enhanced image.

13. (canceled)

14. (canceled)

15. The method of claim 12, further comprising post-processing the enhanced image before compressing the enhanced image.

16.-41. (canceled)

42. An image processing system for automatically processing a series of input images without operator's intervention, comprising:
an image analysis module for automatically analyzing each of the input images;
an image classification module for automatically classifying the analyzed image;
an image enhancement module for automatically enhancing the classified image based on classification; and
an output module for outputting at least one enhanced image.

43. The system of claim 42, wherein the output module outputs a plurality of enhanced images with different file types or file sizes without re-analyzing, re-classifying, and re-enhancing the input image.

44. (canceled)

45. The system of claim 42, wherein the image analysis module, the image classification module, the image enhancement module, and the output module process the input image in real time on-the-fly or in a batch mode.

46.-49. (canceled)

50. The system of claim 42, wherein the image enhancement module applies an individual image enhancement independently to each of the input images.

51. The system of claim 42, further comprising a pre-processor for pre-processing the image before analyzing, classifying, and enhancing the input image.

52. The system of claim 42, further comprising an image resizer for resizing the enhanced image.

53. The system of claim 42, further comprising an image compression module for compressing the enhanced image before outputting the enhanced image.

54. (canceled)

55. (canceled)

56. The system of claim 54, further comprising a post-processor for post-processing the enhanced image before compressing the enhanced image.

57.-64. (canceled)

65. The system of claim 42, wherein the image classification module classifies the image based on a Weighted Means range, a Weighted Standard Deviation range, and a Halve Value Position range of an image luminosity histogram.

66. The system of claim 42, wherein the image enhancement module includes a brightness filter, a contrast filter, a saturation filter, a curve filter, or an unsharp mask filter.

67.-72. (canceled)

73. The system of claim 51, wherein the image pre-processor includes a brightness filter, a contrast filter, a saturation filter, or an unsharp mask filter.

74.-76. (canceled)

77. The system of claim 56, wherein the image post-processor includes a brightness filter, a contrast filter, a saturation filter, or an unsharp mask filter.

78.-114. (canceled)

115. A computer program storage medium readable by a computing system and encoding a computer program of instructions for executing a computer process of automatically processing a series of input images without operator's intervention, in automatically processing each of the input images, the computer process comprising:
providing processing parameters;
automatically analyzing, classifying, and enhancing the input image without operator's intervention; and
outputting at least one enhanced image.

116.-118. (canceled)
